(19) United States
(12) Patent Application Publication
(10) Pub. No.: US 2024/0360271 A1
(43) Pub. Date: Oct. 31, 2024

(54) BIO-BASED AMINE CURING AGENT FOR CURABLE COMPOSITIONS

(71) Applicant: SIKA TECHNOLOGY AG, Baar (CH)

(72) Inventors: Michael HUBER, Zürich (CH); Edis KASEMI, Zürich (CH); Florian HÄFLIGER, Zürich (CH)

(73) Assignee: SIKA TECHNOLOGY AG, Baar (CH)

(21) Appl. No.: 18/689,919

(22) PCT Filed: Oct. 23, 2022
(86) PCT No.: PCT/EP2022/079489

§ 371 Date: Mar. 7, 2024

(30) Foreign Application Priority Data
Oct. 29, 2021 (EP) 21205682.4

(51) Int. Cl. C08G 59/50; C08G 18/32; C08G 18/48; C08G 18/66; C08G 18/78; C08G 59/22; C08G 59/24; C08G 59/56; C08G 59/62; C09D 163/00; C09J 175/12

(52) U.S. Cl. CPC C08G 59/504; C08G 18/3206; C08G 18/325; C08G 18/4812; C08G 18/4825; C08G 18/4829; C08G 18/6674; C08G 18/78; C08G 59/223; C08G 59/245; C08G 59/5033; C08G 59/5046; C08G 59/56; C08G 59/623; C09D 163/00; C09J 175/12

(57) ABSTRACT

The use of a hardener containing at least one amine of formula (I) for crosslinking of amine-reactive compounds, wherein the amines of formula (I) are biobased and obtainable from vanillin or guaiacol. The amines of formula (I) have particularly good compatibility with epoxy resins as the amine-reactive compound. They make it possible to obtain biobased epoxy resin products that are superior to petrobased products not only in terms of sustainability but also in terms of technical performance.

### TECHNICAL FIELD

The present invention relates to the field of polyamines based on renewable raw materials, to processes for production thereof and to the use thereof as hardeners for curable compositions, in particular for epoxy resins.

### PRIOR ART

Polyfunctional amines are used as hardeners for plastics and plastics compositions, for example based on epoxy resins, polyurethanes, polyureas, polyacrylates or polyamides, in a broad range of applications in industry and construction. The amine hardener has a decisive influence on the properties of the plastic and must meet stringent requirements. For epoxy resins for example the amine hardener shall provide for good processability and rapid problem-free curing and result in cured plastics products of high quality, for instance with respect to external appearance, glass transition temperature, water resistance, hardness, brittleness or bonding power. The amine hardeners for epoxy resins known from the prior art, for example 1,3-bis(aminomethyl)benzene, 1,3-bis(aminomethyl)cyclohexane, isophoronediamine or N-benzyl-1,2-ethanediamine, are in need of improvement with respect to processability, open time, curing rate, problem-free curing and/or quality of the surface.

Recent times have seen an increasing demand for plastics products that are sustainable. In particular, they should contain a high content of raw materials from renewable sources, i.e. should be biobased to a great extent. A common measure of the sustainability of chemical raw materials is the Renewable Carbon Index (RCI), which indicates the carbon content from renewable sources. It is obtained by dividing the number of carbon atoms from a renewable source by the total number of carbon atoms in the raw material. While biobased epoxy resins such as for example glycerol triglycidyl ether or vanillin alcohol diglycidyl ether are known, the choice of biobased amine hardeners is still unsatisfactory and their properties are inadequate compared to petrobased amine hardeners.

U.S. Pat. No. 9,676,898 and WO 2015/124792 disclose furan-based amine hardeners. However, their starting materials are difficult to obtain and/or they are susceptible to blushing and/or inadequate in terms of their diluting effect.

There is therefore a need for further biobased amine hardeners having improved properties.

### SUMMARY OF THE INVENTION

It is accordingly an object of the present invention to provide sustainable amine hardeners for plastics and plastics compositions which, compared to known petrobased amine hardeners, make it possible to achieve properties that are not just comparable but actually better, in particular in respect of processability and curing characteristics.

This object is surprisingly achieved with a hardener containing least one amine of formula (I) as described in claim 1. Amines of formula (I) are obtainable from vanillin or guaiacol which are derivable from biobased sources. The hardener according to the invention is suitable for plastics and plastics compositions, in particular based on epoxy resins, polyisocyanates, polyacrylates or polyamides. It makes it possible to obtain biobased plastics products which are superior to petrobased products not only in terms of sustainability but also in terms of technical performance.

Especially in epoxy resin products the hardener can replace customary and widely used petrobased amine hardeners or accelerators such as MXDA or 2,4,6-tris(dimethylaminomethyl) phenol, thus enabling additional advantages. The hardener according to the invention is surprisingly readily compatible with the typically employed epoxy resins such as bisphenol A diglycidyl ether or the biobased vanillin alcohol diglycidyl ether. Compared to 1,3-bis(aminomethyl) phenol (MXDA) it enables significantly faster curing with significantly fewer surface defects due to blushing effects and compared to 2,4,6-tris(dimethylaminomethyl) phenol it enables a higher curing rate with reduced odor.

Further aspects of the invention are the subject of further independent claims. Particularly preferred embodiments of the invention are the subject of the dependent claims.

### Ways of Executing the Invention

The invention provides for the use of a hardener containing at least one amine of formula (I) for crosslinking of amine-reactive compounds,

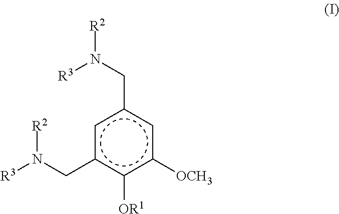

where

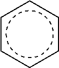

is a benzene ring or cyclohexane ring,
R¹ is H or an alkyl radical having 1 to 6 carbon atoms,
R² is H or a monovalent organic radical having 1 to 6 carbon atoms or an aminoalkyl radical having 2 to 10 carbon atoms or an N-substituted aminoalkyl radical having 2 to 10 carbon atoms and
R³ is H or methyl.

An “amine-reactive compound” is a substance having reactive groups which is capable of reacting with amino groups and, under the influence of the hardener, undergoes chain-growth and crosslinking reactions that ultimately lead to curing.

“RCI” is the “Renewable Carbon Index” of a substance or a mixture of substances, wherein the RCI is the ratio of the number of carbon atoms from biobased sources to the total number of carbon atoms of the substance or the mixture of substances. Substance names beginning with “poly”, such as polyepoxide or polyisocyanate, refer to substances that formally contain two or more of the functional groups that occur in their name per molecule.

A “primary amino group” refers to an amino group that is attached to a single organic radical and bears two hydrogen atoms; a “secondary amino group” refers to an amino group that is attached to two organic radicals, which may also together be part of a ring, and bears one hydrogen atom; and a “tertiary amino group” refers to an amino group that is attached to three organic radicals, two or three of which may also be part of one or more rings, and does not bear any hydrogen atoms.

“Amine hydrogen” refers to the hydrogen atoms of primary and secondary amine groups.

“Amine hydrogen equivalent weight” refers to the mass of an amine or an amine-containing composition that contains one molar equivalent of amine hydrogen. It is expressed in units of “g/eq”.

The “epoxy equivalent weight” refers to the mass of an epoxy-containing compound or composition that contains one molar equivalent of epoxy groups. It is expressed in units of “g/eq”.

A “diluent” refers to a substance that is soluble in an epoxy resin and lowers its viscosity and that is not chemically incorporated into the epoxy resin polymer during the curing process.

“Molecular weight” refers to the molar mass (in grams per mole) of a molecule.

“Average molecular weight” refers to the number-average Mn of a polydisperse mixture of oligomeric or polymeric molecules, which is normally determined by gel-permeation chromatography (GPC) against polystyrene as standard.

“Room temperature” refers to a temperature of 23° C.

All industry standards and norms mentioned in this document refer to the versions valid at the date of first filing, unless otherwise stated.

Percent by weight (% by weight) values refer to the mass fractions of a constituent in a composition based on the overall composition, unless otherwise stated. The terms “mass” and “weight” are used synonymously in the present document.

Amine-reactive compounds contain reactive groups such as in particular epoxy groups, isocyanate groups, acrylate groups, methacrylate groups, acrylamide groups, methacrylamide groups, carboxylic acid groups, carboxylic ester groups, acetoacetate groups, 1,3-diketogroups, carbonate groups or lactone groups. The amine of formula (I) may be incorporated into the resulting polymer network during crosslinking or can act as a catalyst for crosslinking of the amine-reactive compound by homopolymerization.

It is preferable when the amine-reactive compound is an epoxy resin, a polyisocyanate, a poly(meth)acrylate, a polycarboxylic acid or a carboxylic anhydride.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl) methane, 2,2-bis(4-hydroxy-3-methylphenyl) propane (bisphenol C), bis(3,5-dimethyl-4-hydroxyphenyl) methane, 2,2-bis(3,5-dimethyl-4-hydroxyphenyl) propane, 2,2-bis(3,5-dibromo-4-hydroxyphenyl) propane, 2,2-bis(4-hydroxy-3-tert-butylphenyl) propane, 2,2-bis(4-hydroxyphenyl) butane (bisphenol B), 3,3-bis(4-hydroxyphenyl) pentane, 3,4-bis(4-hydroxyphenyl) hexane, 4,4-bis(4-hydroxyphenyl) heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl) methane, bis(4-hydroxynaphth-1-yl) methane, 1,5-dihydroxynaphthalene, tris(4-hydroxyphenyl) methane, 1,1,2,2-tetrakis(4-hydroxyphenyl) ethane, bis(4-hydroxyphenyl) ether or bis(4-hydroxyphenyl) sulfone;
novolacs, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi (N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

Further suitable epoxy resins are epoxy resins having a high RCI, especially those from the reaction of biobased hydroxy-functional raw materials with biobased epichlorohydrin. Particular preference is given to vanillin-based epoxy resins such as, in particular, vanillin alcohol diglycidyl ether or the glycidyl ethers of bisvanillin derivatives, and glycerol-based epoxy resins such as, in particular, the glycidyl ethers of glycerol or polyglycerol.

The epoxy resin is preferably a liquid resin or a mixture containing two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol or novolac, especially having an average epoxy equivalent weight in the range from 156 to 210 g/eq.

Suitable polyisocyanates are in particular diisocyanates, oligomers or derivatives of diisocyanates or isocyanate-containing polymers, in particular from the reaction of polyols with diisocyanates.

Suitable diisocyanates are in particular 1,6-hexamethylene diisocyanate (HDI), 2,2,4-and/or 2,4,4-trimethyl-1,6-hexamethylene diisocyanate (TMDI), 1-methyl-2,4 (6)-diisocyanatocyclohexane (H₆TDI), isophorone diisocyanate (IPDI), perhydro-4 (2),4′-diphenylmethane diisocyanate (H₁₂MDI), 4 (2),4′-diphenylmethane diisocyanate (MDI) or 2,4 (6)-toluene diisocyanate.

Suitable oligomers or derivatives of diisocyanates are in particular oligomers or derivatives derived from HDI, IPDI, MDI or TDI, which especially contain uredione, isocyanurate, iminooxadiazindione, ester, urea, urethane, biuret, allophanate, carbodiimide, uretonimine and/or oxadiazinetrione groups, in particular HDI biurets, HDI isocyanurates, HDI uretdiones, HDI iminooxadiazinediones, HDI allophanates, IPDI isocyanurates, TDI oligomers or mixed isocyanurates based on TDI/HDI or forms of MDI liquid at room temperature (so-called “modified MDI”) which are mixtures of MDI with MDI derivatives, such as in particular MDI carbodiimides or MDI uretonimines or MDI urethanes, as well as MDI homologs or mixtures thereof with MDI (polymeric MDI or PMDI). They especially have an average NCO functionality of 2.1 to 4.0.

Suitable isocyanate-containing polymers are especially derived from polyether polyols, polyester polyols, polycarbonate polyols, poly(meth)acrylate polyols, polybutadiene polyols or polyhydroxy-functional fats and oils with HDI, IPDI, H₁₂MDI, MDI or TDI. The polyols especially have an average OH functionality of 1.6 to 3. The polymers especially have an average molecular weight of 1000 to 15 000 g/mol. The polymers especially have a content of isocyanate groups of 0.5% to 30% by weight, preferably 1% to 25% by weight, particularly preferably 2% to 20% by weight. The polymers are especially produced with an NCO: OH ratio in the range from 1.5:1 to 10:1. Unconverted monomeric diisocyanates have optionally been removed from the polymer.

Suitable poly(meth)acrylates are in particular ethylene glycol di(meth)acrylate, tetraethylene glycol di(meth)acrylate, tripropylene glycol di(meth)acrylate, polyethylene glycol di(meth)acrylate or polypropylene glycol di(meth)acrylate, in particular having an average molecular weight of 200 to 2000 g/mol, 1,4-butanediol di(meth)acrylate, 1,6-hexanediol di(meth)acrylate, neopentyl glycol di(meth)acrylate, trimethylolpropane tri(meth)acrylate, pentaerythritol tetra(meth)acrylate, dipentaerythritol tetra(meth)acrylate, dipentaerythritol penta(meth)acrylate, dipentaerythritol hexa(meth)acrylate, tris(2-hydroxyethyl) isocyanurate tri(meth)acrylate, tris(2-hydroxyethyl) cyanurate tri(meth)acrylate, di- or polyfunctional acryloyl- or methacryloyl-functional polybutadienes or polyisoprenes or block copolymers thereof, di- or polyfunctional polyurethane(meth)acrylates, in particular reaction products of isocyanate-containing polymers, in particular having an average molecular weight of 500 to 20 000 g/mol, with hydroxy-functional(meth)acrylates such as in particular 2-hydroxyethyl acrylate.

Suitable polycarboxylic acids are in particular oxalic acid, malonic acid, succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, methylhexahydrophthalic acid, hexahydroterephthalic acid, dimer fatty acids, 3,6,9-trioxaundecanedioic acid or dicarboxylic acids of higher molecular weight polyethylene glycols, citric acid, phthalic acid, isophthalic acid or terephthalic acid.

Suitable carboxylic anhydrides are in particular succinic anhydride, maleic anhydride, hexahydrophthalic anhydride, methylhexahydrophthalic anhydride, tetrahydrophthalic anhydride, phthalic anhydride, methylphthalic anhydride, trimellitic anhydride, pyromellitic dianhydride, or 4.4′-[(isopropylidene)-bis(p-phenyleneoxy)]diphthalic dianhydride.

It is particularly preferable when the amine-reactive compound is an epoxy resin. As a constituent of a hardener for epoxy resins the amine of formula (I) makes it possible to achieve particularly advantageous properties.

Particularly suitable epoxy resins include bisphenol A diglycidyl ethers and/or bisphenol F diglycidyl ethers, as are commercially available for example from Olin, Huntsman or Momentive. These liquid resins have a low viscosity for epoxy resins and provide for rapid curing and high hardnesses. They may contain proportions of solid bisphenol A resin or novolac epoxy resins.

Very particular preference is given to a bisphenol A diglycidyl ether having an RCI of 0.3 from the reaction of bisphenol A with biobased epichlorohydrin. This makes it possible to achieve a particularly sustainable epoxy resin composition. Particularly suitable epoxy resins further include phenol-formaldehyde novolac glycidyl ethers, especially having an average functionality in the range from 2.3 to 4, preferably 2.5 to 3. These may contain proportions of other epoxy resins, in particular bisphenol A diglycidyl ether or bisphenol F diglycidyl ether. Particularly suitable epoxy resins further include vanillin alcohol diglycidyl ethers or the glycidyl ethers of glycerol or polyglycerol, in particular vanillin alcohol diglycidyl ethers.

R¹ is preferably an alkyl radical having 1 to 6 carbon atoms, in particular methyl. Such an amine of formula (I) makes it possible to achieve curable compositions of particularly low viscosity.

Such an amine of formula (I) is preferably produced from vanillin (4-hydroxy-2-methoxybenzaldehyde) where the free ortho position to the phenol group is alkylated with a formyl group from hexamethylenetetramine in a Duff reaction to afford 5-formylvanillin, the phenol group is then alkylated and finally the obtained dialdehyde of formula (II) is subjected to reductive amination with an amine of formula (III) or hydroxylamine, wherein R¹, R² and R³ have the aforementioned definitions.

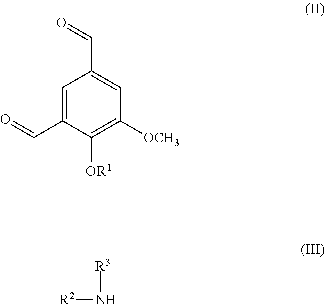

In a preferred embodiment of the invention R² and R³ are both H. Such an amine of formula (I) is a primary diamine and particularly suitable as a hardener. It provides for particularly rapid curing and a particularly high final hardness.

It is it is preferable when R¹ is methyl and the amine of formula (I) is thus 1,3-bis(aminomethyl)-4,5-dimethoxybenzene (Ia) or 1,3-bis(aminomethyl)-4,5-dimethoxycyclohexane (Ib).

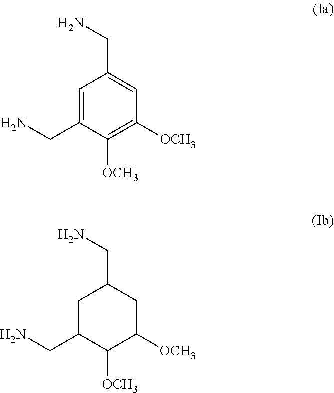 [SMILES: COc1cc(CN)cc(CN)c1OC ; COC1CC(CN)CC(CN)C1OC]

Such an amine of formula (I) makes it possible to obtain curable compositions with rapid curing and high final hardness, in particular also epoxy resin products having a high glass transition temperature.

1,3-bis(aminomethyl)-4,5-dimethoxybenzene (Ia) is liquid at room temperature and in the crosslinking of epoxy resins enables faster curing coupled with markedly fewer surface defects due to blushing effects compared to petrobased 1,3-bis(aminomethyl) phenol (MXDA).

1,3-bis(aminomethyl)-4,5-dimethoxycyclohexane (Ib) is liquid at room temperature and makes it possible to achieve high lightfastness coupled with a low tendency to yellowing and surprisingly rapid curing with epoxy resins.

The amines of formula (Ia) or (Ib) are especially obtainable from the reductive amination of the corresponding dialdehyde of formula (II) with ammonia or hydroxylamine, wherein the hydrogenation conditions are selected such that the benzene ring is largely not hydrogenated and the amine of formula (Ia) is formed or the benzene ring is likewise largely hydrogenated and the amine of formula (Ib) is formed.

In a further preferred embodiment of the invention R³ is H and R² is a monovalent organic radical having 1 to 6 carbon atoms, in particular methyl, ethyl, propyl, isopropyl, butyl, isobutyl, cyclohexyl, benzyl, furfuryl or tetrahydrofurfuryl. R¹ is preferably methyl. Such an amine of formula (I) makes it possible to achieve a particularly long open time, a particularly low exothermicity during curing and, in the case of an epoxy resin composition, a particularly low tendency to blushing effects.

It is particularly preferable when R² is furfuryl or tetrahydrofurfuryl and R³ is H. R¹ is preferably methyl. Such an amine of formula (I) has a low viscosity and a high RCI. It is especially obtainable from the reductive amination of 4,5-dimethoxyisophthalaldehyde as the dialdehyde of formula (II) with furfurylamine, in particular a furfurylamine from a biobased source, wherein the hydrogenation conditions are selected such that the furan ring is largely not hydrogenated and mainly 1,3-bis(furfurylaminomethyl)-4,5-dimethoxybenzene (IC) is formed or the hydrogenation conditions are selected such that the furan ring is likewise largely hydrogenated while the benzene ring is not hydrogenated and mainly 1,3-bs (tetrahydrofurfurylaminomethyl)-4,5-dimethoxybenzene (Id) is formed or the hydrogenation conditions are selected such that the furan ring and the benzene ring are both likewise hydrogenated and thus mainly 1,3-bis(tetrahydrofurylaminomethyl)-4,5-dimethoxycyclohexane (IE) is formed.

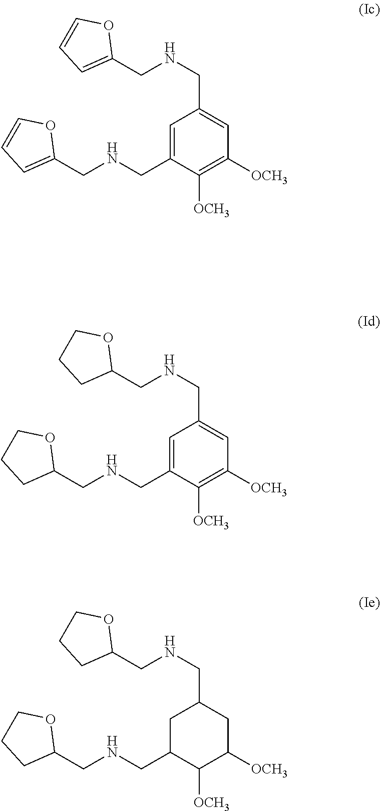 [SMILES: COc1cc(CNCc2ccco2)cc(CNCc2ccco2)c1OC ; COc1cc(CNCC2CCCO2)cc(CNCC2CCCO2)c1OC ; COC1CC(CNCC2CCCO2)CC(CNCC2CCCO2)C1OC]

In the case of the amine of formula (Ic) and/or (Id) the reaction product typically also contains the corresponding co-hydrogenated amines of formulae

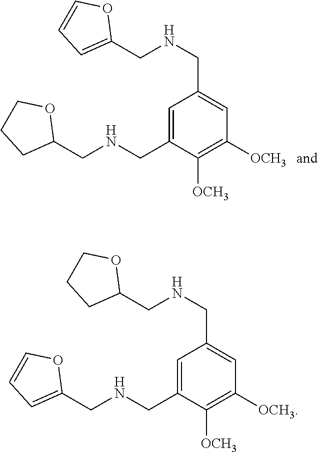 [SMILES: COc1cc(CNCc2ccco2)cc(CNCC2CCCO2)c1OC ; "and" ; COc1cc(CNCC2CCCO2)cc(CNCc2ccco2)c1OC]

These aforementioned preferred amines of formula (I) are especially diamines having primary and/or secondary amino groups. They are particularly suitable as

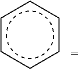

hardeners for the aforementioned amine-reactive compounds, either with benzene ring or cyclohexane ring. The benzene ring typically provides for a particularly high final hardness while the cyclohexane ring provides for a particularly low tendency to yellowing.

The amines of formula (I) described below are particularly suitable as hardeners for epoxy resins as the amine-reactive compound.

In a preferred embodiment of the invention R¹ is H and

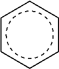

is a benzene ring. Such an amine of formula (I) contains a phenol group. It is also known as a Mannich base and provides for particularly fast curing of epoxy resins. It is preferably produced by reaction of guaiacol (2-methoxyphenol), formaldehyde and at least one amine of formula (III) in a Mannich reaction.

In a preferred embodiment of the invention R¹ is H,

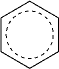

is a benzene ring and R² and R³ are both methyl. The amine of formula (I) is thus 2,4-bis(dimethylaminomethyl)-6-methoxyphenol (If).

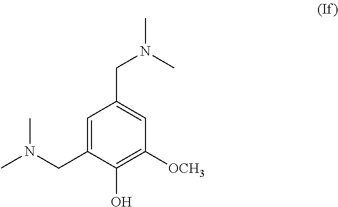 [SMILES: COc1cc(CN(C)C)cc(CN(C)C)c1O]

This amine has a low viscosity and is particularly suitable as a co-hardener and/or accelerator for the curing of epoxy resins. It provides for readily processable epoxy resin products with surprisingly rapid curing and low odor, in particular compared to the known petrobased accelerator 2,4,6-tris(dimethylaminomethyl) phenol.

2.4-bis(dimethylaminomethyl)-6-methoxyphenol (If) is preferably produced from the reaction of guaiacol, formaldehyde and dimethylamine in a Mannich reaction.

It is likewise possible to produce the amine of formula (If) from the reductive amination of a dialdehyde of formula (II) where R¹ is H with dimethylamine. The hydrogenation is preferably carried out particularly gently, in particular at normal pressure and by reaction with sodium borohydride for example, wherein the obtained reaction product is preferably purified by distillation.

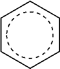

Also preferable is an amine of formula (I) where is a benzene ring, R¹ is H, R² is furfuryl and R³ is H. The amine of formula (I) is thus 2,4-bis(furfurylaminomethyl)-6-methoxyphenol (Ig).

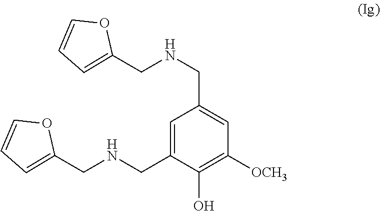 [SMILES: COc1cc(CNCc2ccco2)cc(CNCc2ccco2)c1O]

This amine is especially obtained from the reaction of guaiacol, furfurylamine and formaldehyde or from the transamination of 2,4-bis(dimethylaminomethyl)-6-methoxyphenol (If) with furfurylamine with liberation and removal of dimethylamine. The amine of formula (Ig) especially has an RCI of 1 and provides for epoxy resin products that cure largely without any surface defects caused by blushing.

In a further preferred embodiment of the invention R³ is H and R² is a linear aminoalkyl radical having 2 to 6 carbon atoms, in particular 2-aminoethyl. Such an amine of formula (I) enables a particularly high crosslinking density, particularly high bonding forces and high glass transition temperatures.

R¹ is preferably methyl.

It is particularly preferable when R¹ is methyl, R² is 2-aminoethyl and R³ is H. The amine of formula (I) is thus especially 1,3-bis(N-(2-aminoethyl)aminomethyl)-4,5-dimethoxybenzene (Ih) or 1,3-bis(N-(2-aminoethyl)aminomethyl)-4,5-dimethoxycyclohexane (Ii).

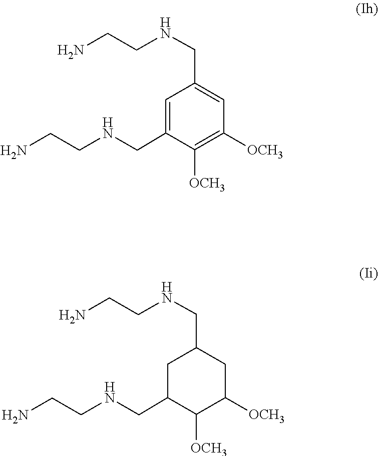 [SMILES: COc1cc(CNCCN)cc(CNCCN)c1OC ; COC1CC(CNCCN)CC(CNCCN)C1OC]

The amines of formulae (Ih) or (Ii) are especially obtained from the reductive amination of 4,5-dimethoxyisophthalaldehyde as the dialdehyde of formula (II) with an excess of 1,2-ethanediamine as the amine of formula (III) and subsequent removal of unconverted 1,2-ethanediamine. A reaction product thus obtained typically contains higher-molecular fractions with dialkylated 1,2-ethanediamine. It may be freed of such fractions by distillation if desired.

Particular preference is given to an amine of formula (Ih) that has been freed of higher-molecular fractions by distillation.

In a further preferred embodiment of the invention R³ is H and R² is an N-substituted aminoalkyl radical having 2 to 10 carbon atoms, in particular 2-benzylaminoethyl, 2-furfurylaminoethyl or 3-dimethylaminopropyl.

It is preferable when

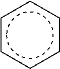

is a benzene ring and R¹ is H or methyl. Particular preference is thus given to 2,4-bis((2-furfurylaminoethyl)aminomethyl)-6-methoxyphenol (Ij), 1,3-bis((2-furfurylaminoethyl)aminomethyl)-4,5-dimethoxybenzene (Ik), 2,4-bis((2-benzylaminoethyl)aminomethyl)-6-methoxyphenol (Im), 1,3-bis((2-benzylaminoethyl)aminomethyl)-4,5-dimethoxybenzene (In), 2,4-bis(3-dimethylaminopropylaminomethyl)-6-methoxyphenol (Io) or 1,3-bis(3-dimethylaminopropylaminomethyl)-4,5-dimethoxybenzene (Ip).

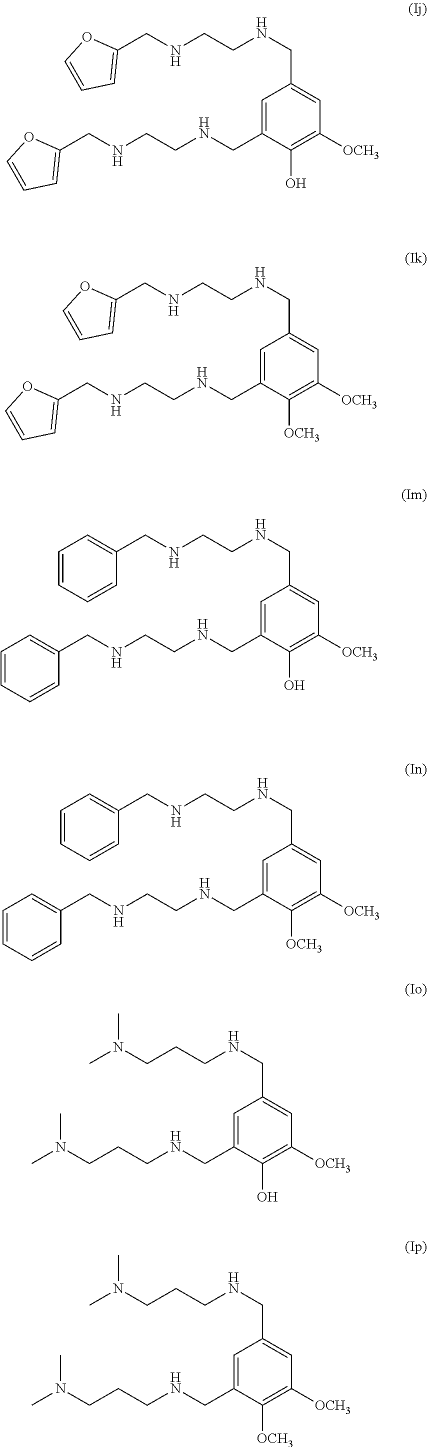 [SMILES: COc1cc(CNCCNCc2ccco2)cc(CNCCNCc2ccco2)c1O ; COc1cc(CNCCNCc2ccco2)cc(CNCCNCc2ccco2)c1OC ; COc1cc(CNCCNCc2ccccc2)cc(CNCCNCc2ccccc2)c1O ; COc1cc(CNCCNCc2ccccc2)cc(CNCCNCc2ccccc2)c1OC ; COc1cc(CNCCCN(C)C)cc(CNCCCN(C)C)c1O ; COc1cc(CNCCCN(C)C)cc(CNCCCN(C)C)c1OC]

The amines of formulae (Ij), (Im) and (Io) are especially obtained from the reaction of guaiacol with N-furfuryl-1,2-ethanediamine or N-benzyl-1,2-ethanediamine or 3-dimethylaminopropylamine as the amine of formula (III) or from the transamination of 2,4-bis(dimethylaminomethyl)-6-methoxyphenol (If) with N-furfuryl-1,2-ethanediamine or N-benzyl-1,2-ethanediamine or 3-dimethylaminopropylamine and removal of dimethylamine.

The amines of formulae (Ik), (In) and (Ip) are especially obtained from the reductive amination of 4,5-dimethoxyisophthalaldehyde as the dialdehyde of formula (II) with N-furfuryl-1,2-ethanediamine or N-benzyl-1,2-ethanediamine or 3-dimethylaminopropylamine as the amine of formula (III).

In a preferred embodiment of the invention in the amine of formula (I) the radicals R² on the two nitrogen atoms are in each case different radicals.

It is preferable when R¹ is methyl, both radicals R³ are H, one of the radicals R² is H and the other radical R² is methyl, ethyl, propyl, isopropyl, butyl, isobutyl, cyclohexyl, benzyl, furfuryl, tetrahydrofurfuryl or 3-dimethylaminopropyl.

In the case of

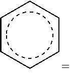

benzene ring the amine of formula (I) is thus especially an amine of formula (Iq) or (Ir) or an amine of formula (Is) or (It) or an amine of formula (Iu) or (Iv) or an amine of formula (Iw) or (Ix) or an amine of formula (Iy) or (Iz).

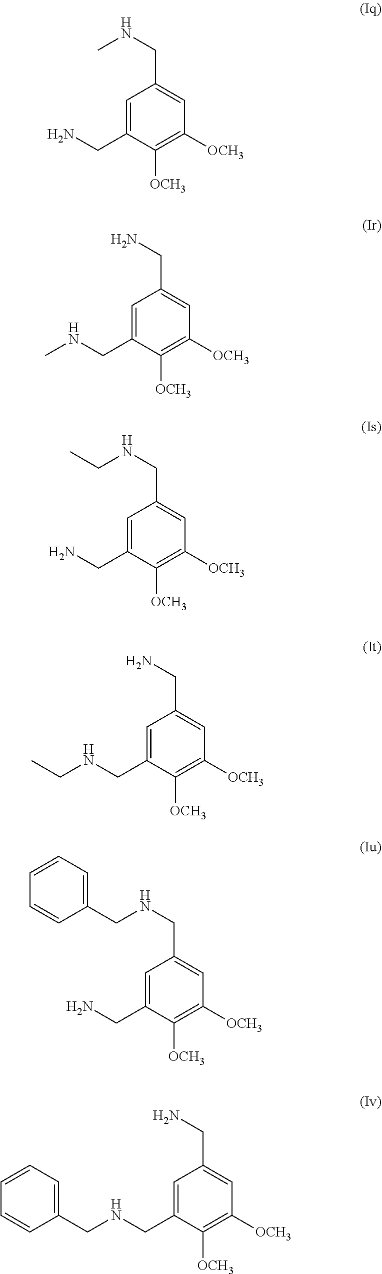 [SMILES: CNCc1cc(CN)c(OC)c(OC)c1 ; CNCc1cc(CN)cc(OC)c1OC ; CCNCc1cc(CN)c(OC)c(OC)c1 ; CCNCc1cc(CN)cc(OC)c1OC ; COc1cc(CNCc2ccccc2)cc(CN)c1OC ; COc1cc(CN)cc(CNCc2ccccc2)c1OC]

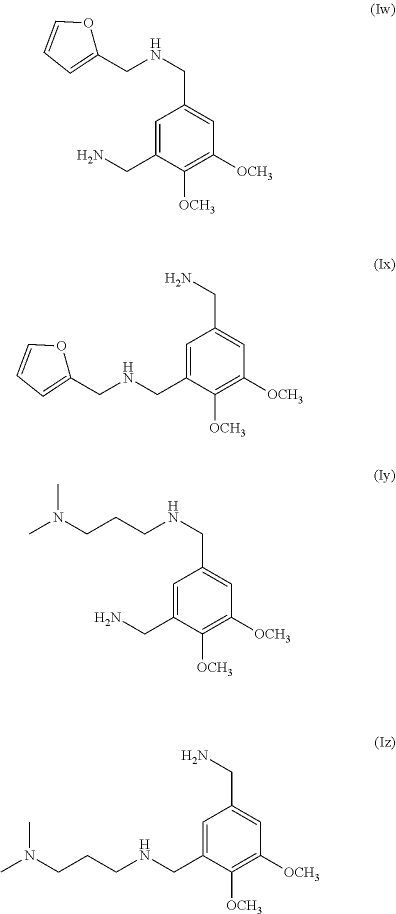 [SMILES: COc1cc(CNCc2ccco2)cc(CN)c1OC ; COc1cc(CN)cc(CNCc2ccco2)c1OC ; COc1cc(CNCCCN(C)C)cc(CN)c1OC ; COc1cc(CN)cc(CNCCCN(C)C)c1OC]

The amines of formulae (Iq) to (Ix) are suitable as hardeners for all aforementioned amine-reactive compounds while the amines of formulae (Iy) and (Iz) are particularly suitable as hardeners for epoxy resins.

The amines of formulae (Iq) to (Iz) are derived in particular from the reductive amination of 4,5-dimethoxyisophthalaldehyde as the dialdehyde of formula (II) with ammonia or hydroxylamine and methylamine, ethylamine, propylamine, isopropylamine, butylamine, Isobutylamine, cyclohexylamine, benzylamine, furfurylamine or 3-dimethylaminopropylamine as a further amine of formula (III).

Such amines provide for an interesting combination of long open time coupled with rapid through-curing and a low tendency to blushing effects coupled with rapid curing. They are typically a constituent of a reaction product which additionally contains the two corresponding symmetrically substituted amines of formula (I), i.e. in the case of amine of formulae (Iw) and (Ix) 1,3-bis(aminomethyl)-4,5-dimethoxybenzene (Ia) and 1,3-bis(furfurylaminomethyl)-4,5-dimethoxybenzene (Ic) and in the case of amine of formulae (Iy) and (Iz) 1,3-bis(aminomethyl)-4,5-dimethoxybenzene (Ia) and 1,3-bis(3-dimethylaminopropylaminomethyl)-4,5-dimethoxybenzene (Ip).

As mentioned above the recited amines of formula (I) may be produced in different ways.

An amine of formula (I), wherein R¹ is an alkyl radical having 1 to 6 carbon atoms, in particular methyl, is preferably obtained from a process where
(i) in a first step vanillin is reacted with hexamethylenetetramine and water in the presence of acid to afford 5-formylvanillin,
(ii) in a second step 5-formylvanillin is alkylated at the phenol group to afford a dialdehyde of formula (II) and
(iii) in a third step the dialdehyde of formula (II) is condensed with at least one amine of formula (III) or hydroxylamine and hydrogenated with hydrogen to afford the amine of formula (I).

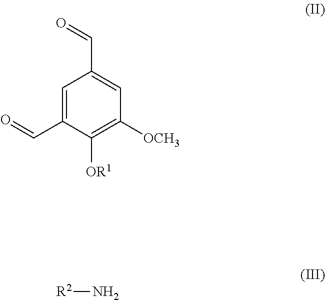

The vanillin employed in the process is preferably biobased and has an RCI of 1. It is particularly preferably derived from a decomposition process of lignin. Such grades of vanillin are commercially available, for example as EuroVanillin Supreme, EuroVanillin Regular or EuroVanillin Aromatic (from Borregaard). In the first step of the process the vanillin is reacted with hexamethylenetetramine and water in the presence of acid to introduce a formyl group at the free ortho position to the phenol group and thus obtain 5-formylvanillin (4-hydroxy-5-methoxyisophthalaldehyde) (Duff reaction). Preferred acids include sulfuric acid, trifluoroacetic acid, acetic acid or a mixture of two or more of these acids. Hexamethylenetetramine (1,3,5,7-tetraazaadamantane) serves as a source for the formyl group. For its part, it is obtained from reaction of formaldehyde and ammonia and is obtainable inexpensively. It is preferable to employ a grade of hexamethylenetetramine which is produced from biobased formaldehyde. It is preferable to employ the vanillin and the hexamethylenetetramine in a molar ratio of about 1:1. The vanillin and the hexamethylenetetramine are preferably mixed with the acid, optionally in the presence of a suitable solvent. The acid preferably serves to dissolve the vanillin and the hexamethylenetetramine without requiring the presence of a further organic solvent. The reaction mixture is preferably heated, especially to a temperature in the range from 80° C. to 150° C., and after a suitable reaction time, in particular after several hours, admixed with water or an aqueous acid such as especially hydrochloric acid and reacted further before the reaction mixture is cooled and admixed with a suitable organic solvent, for example dichloromethane, to take up the 5-formylvanillin formed into the organic phase and separate it from the further reagents. The solvent of the organic phase is then removed by distillation and 5-formylvanillin (=dialdehyde of formula (II) with R¹═H) is obtained as a crystalline solid. For purification, the obtained solid may be recrystallized, for example from toluene.

In the second step of the process 5-formylvanillin is alkylated at the phenol group by a suitable method to obtain a dialdehyde of formula (II) where R¹=alkyl radical having 1 to 6 carbon atoms. If a biobased alkylating agent is employed the obtained dialdehyde especially further has an RCI of 1. Suitable alkylating agents are especially alkyl halides, carboxylic acids or esters of sulfuric acid, sulfonic acids, phosphoric acid or phosphonic acids, preferably dimethyl sulfate, diethyl sulfate or formic acid. The phenol group is preferably methylated, in particular by reaction with dimethyl sulfate or formic acid. This especially affords 4,5-dimethoxyisophthalaldehyde (dialdehyde of formula (II) with R¹=methyl) as a crystalline solid.

In the third step of the process the dialdehyde of formula (II) is condensed with at least one amine of formula (III) or hydroxylamine and hydrogenated with hydrogen to afford the amine of formula (I). This reaction is also referred to as reductive amination. The intermediate product formed is an imine of formula (IV) or—in the case of hydroxylamine—a dioxime of formula (V) which may be isolated if desired or preferably is not isolated and is hydrogenated directly with hydrogen to afford the amine of formula (I).

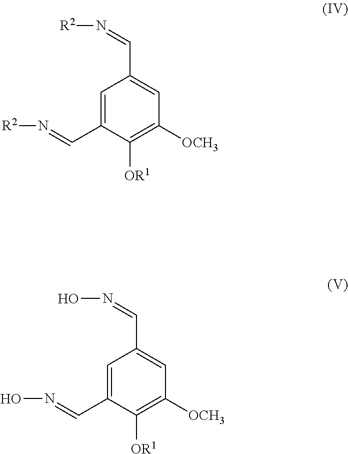

It is preferable to employ at least 2 mol of amine of formula (III) or hydroxylamine per mol of dialdehyde of formula (II).

Hydrogenation may be effected directly with molecular hydrogen or indirectly through hydrogen or hydride transfer from other reagents, for example formic acid, lithium aluminum hydride or sodium borohydride. The hydrogenation is preferably effected with molecular hydrogen.

The hydrogenation is preferably conducted in the presence of a suitable catalyst. Preferred catalysts are palladium on charcoal (Pd/C), platinum on charcoal (Pt/C), Adams' catalyst or Raney nickel, especially palladium on charcoal or Raney nickel.

When molecular hydrogen is used the hydrogenation is preferably run in a pressure apparatus at a hydrogen pressure of 5 to 300 bar. This may be effected in a batchwise process or preferably in a continuous process.

The hydrogenation is preferably conducted at a temperature in the range from 40° C. to 150° C.

The hydrogenation conditions may be selected such that the aromatic ring is not hydrogenated to form an amine of formula (I) where

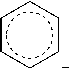

benzene ring.

However, the hydrogenation conditions may also be selected such that the aromatic ring is likewise hydrogenated to afford an amine of formula (I) where

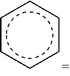

cyclohexane ring.

If the aromatic ring is not to be hydrogenated in the hydrogenation this is preferably operated at a temperature in the range from 60° C. to 120° C. and a hydrogen pressure in the range from 10 to 120 bar. Otherwise, preference is given to operation at a temperature in the range from 80° C. to 150° C. and a hydrogen pressure in the range from 150 to 250 bar.

The volatile components, especially liberated water and any solvent present, are preferably removed from the reaction product after the hydrogenation, especially by distillation or stripping.

Suitable amines of formula (III) especially include the aforementioned, in particular ammonia, methylamine, ethylamine, propylamine, isopropylamine, butylamine, isobutylamine, cyclohexylamine, benzylamine, furfurylamine, 1,2-ethanediamine, 1,3-propanediamine, 1,4-butanediamine, 1,5-pentanediamine, 1,6-hexanediamine, N-benzyl-1,2-ethanediamine, N-furfuryl-1,2-ethanediamine, or 3-dimethylaminopropylamine.

In the case of ammonia as the amine of formula (III) it is preferable to react significantly more than 2 mol of ammonia per mol of dialdehyde of formula (II) in a pressure apparatus at a hydrogen pressure of 5 to 300 bar to afford the amine of formula (I) where R² and R³═H.

For a laboratory synthesis it is preferable to employ hydroxylamine instead of ammonia, in particular about 2 mol of hydroxylamine per mol of dialdehyde of formula (II).

In the case of an amine having a primary amino group and no further amine hydrogens as the amine of formula (III), such as methylamine, ethylamine, propylamine, isopropylamine, butylamine, isobutylamine, cyclohexylamine, benzylamine, furfurylamine or 3-dimethylaminopropylamine, it is preferable to employ about 2 mol of the amine of formula (III) per mol of dialdehyde of formula (II).

In the case of a primary diamine as the amine of formula (III), such as 1,2-ethanediamine, 1,3-propanediamine, 1,4-butanediamine, 1,5-pentanediamine or 1,6-hexanediamine, it is preferable to employ more than 2 mol of amine of formula (III) per mol of dialdehyde of formula (II). It is preferable to employ at least 4 mol, in particular 6 to 20 mol, of an amine of formula (III) where R²=aminoalkyl radical and R³═H per mol of dialdehyde of formula (II) and the excess of amine of formula (III) is preferably removed, in particular after hydrogenation together with the liberated water and any solvent present, in particular by distillation or stripping.

In the case of a diamine having a primary amino group and a secondary amino group as the amine of formula (III), such as N-benzyl-1,2-ethanediamine or N-furfuryl-1,2-ethanediamine, it is preferable to employ about 2 mol of the amine of formula (III) per mol of dialdehyde of formula (II). However, it is also possible to employ more than 2 mol of such an amine of formula (III), in particular 2.5 to 10 mol. The excess amine of formula (III) is preferably not removed from the reaction product and the obtained amine of formula (I) is thus employed as hardener together with the unreacted amine of formula (III).

An amine of formula (I) where R¹ is H and

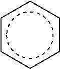

is a benzene ring is preferably produced by a Mannich reaction, wherein guaiacol (2-methoxyphenol) is reacted with formaldehyde and at least one amine of formula (III) to liberate water. It is preferable when guaiacol and the amine of formula (III) are initially charged and the formaldehyde, optionally in the form of 1,3,5-trioxane or paraformaldehyde, is added slowly, wherein the temperature of the reaction mixture is preferably maintained in the range from about 50° C. to 150° C. The liberated water and any solvent present are subsequently removed by distillation. It is preferable to employ 2 to 20 mol, in particular 2 bis 10 mol, of amine of formula (III) and 2 to 3 mol, preferably about 2 mol, of formaldehyde per mol of guaiacol. Unreacted amine of formula (III) is optionally removed by distillation together with the liberated water.

It is preferable to employ formaldehyde from a biobased source.

It is preferable to employ guaiacol from a biobased source.

Suitable amines of formula (III) are the aforementioned, in particular dimethylamine, furfurylamine, 3-dimethylaminopropylamine, N-benzyl-1,2-ethanediamine or N-furfuryl-1,2-ethanediamine.

Dimethylamine is particularly suitable. The particularly preferred 2,4-bis(dimethylaminomethyl)-6-methoxyphenol (If) is thus obtained in high purity.

Further amines of formula (I) where R¹ is H and

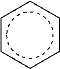

is a benzene ring are obtainable from 2,4-bis(dimethylaminomethyl)-6-methoxyphenol (If) by transamination as mentioned above. For transamination 2,4-bis(dimethylaminomethyl)-6-methoxyphenol (If) is admixed with the respective amine of formula (III) and heated at a temperature in the range from 80° C. to 160° C. with distillative removal of dimethylamine. This replaces dimethylamino radicals with the radical of the employed amine of formula (III). In the case of 3-dimethylaminopropylamine as the amine of formula (III) complete transamination affords 2,4-bis(3-dimethylaminopropylaminomethyl)-6-methoxyphenol (Io). It is preferable to employ 1 to 10 mol of amine of formula (III) per mol of 2,4-bis(dimethylaminomethyl)-6-methoxyphenol (If). It is particularly preferable to employ 2 to 10 mol, in particular 2 to 5 mol, of amine of formula (III) per mol of 2,4-bis(dimethylaminomethyl)-6-methoxyphenol (If). If more than 2 mol of amine of formula (III) are employed for the transamination the reaction product typically contains unconverted amine of formula (III). Such a reaction product has a particularly low viscosity and may be used as such for the curing of epoxy resins. However, it may also be purified by distillative removal of unconverted amine of formula (III).

The amine of formula (I) is used as a constituent of a hardener for crosslinking amine-reactive compounds.

For crosslinking of polyisocyanates, poly(meth)acrylates, polycarboxylic acids or carboxylic anhydrides preference is given to amines of formula (I) in which R³ is H in each case and which thus contain primary and/or secondary amino groups.

In the case of polyisocyanates as the amine-reactive compound the crosslinking with such amines of formula (I) forms urea groups and the products may be referred to as polyureas or polyurethanes.

The amine of formula (I) may be used for example as a constituent of a hardener for crosslinking of polyisocyanates, wherein the hardener additionally contains at least one polyol. The amine of formula (I) may be employed in a highly subtoichiometric ratio with respect to the isocyanate groups, wherein upon mixing of the hardener with the polyisocyanate the amine of formula (I) immediately causes thickening on account of the very rapid crosslinking reaction, the mixed composition thereby having a high sag resistance very quickly as is advantageous for certain applications. Especially suitable therefor are 1,3-bis(aminomethyl)-4,5-dimethoxybenzene (Ia) or 1,3-bis(aminomethyl)-4,5-dimethoxycyclohexane (Ib).

In the case of poly(meth)acrylates as the amine-reactive compound, primary and/or secondary amino groups of such amines of formula (I) undergo addition reaction with the activated double bonds in the course of crosslinking.

In the case of polycarboxylic acids or carboxylic anhydrides as the amine-reactive compound the crosslinking with amines of formula (I) having primary and/or secondary amino groups forms polyamides.

It is particularly preferable to employ the amine of formula (I) as a constituent of a hardener for crosslinking of epoxy resins.

Described hereinbelow is a hardener which is particularly suitable for crosslinking of epoxy resins.

The hardener may especially contain more than one amine of formula (I). In the case of 2,4-bis(dimethylaminomethyl)-6-methoxyphenol (If) as the amine of formula (I) the hardener preferably contains at least one further amine which may be a further amine of formula (I) or a further amine not conforming to formula (I).

An amine of formula (I) where R³ is H may be employed in the form of an amine-functional adduct with at least one epoxy resin. Preference is given to adducts with a monoepoxide, in particular in a ratio of 1 to 10 mol, preferably 1 to 5 mol, of amine of formula (I) per mol of monoepoxide. Particular preference is given to adducts with a polyepoxide, in particular a diepoxide, in particular in a ratio of 1.4 to 10 mol, preferably 1.5 to 5 mol, of amine of formula (I) per mole equivalent of epoxy groups of the polyepoxide.

Suitable monoepoxides especially include phenyl glycidyl ether, cresyl glycidyl ether or tert-butylphenyl glycidyl ether. Suitable polyepoxides especially include bisphenol A diglycidyl ether, bisphenol F diglycidyl ether, polyoxypropylene glycol diglycidyl ether, polyoxyethylene glycol diglycidyl ether or phenol-formaldehyde novolac glycidyl ether, in particular bisphenol A diglycidyl ether.

The hardener preferably contains at least one further constituent selected from further amines not conforming to formula (I), accelerators and diluents, in particular at least one further amine not conforming to formula (I).

It is preferable when the hardener contains at least one further amine which does not conform to formula (I) and which is not a byproduct from the production of the amine of formula (I).

Preferred further amines not conforming to formula (I) are amines having aliphatic amino groups and at least three amine hydrogens, in particular N-benzyl-1,2-ethanediamine, N-benzyl-1,2-propanediamine, N-benzyl-1,3-bis(aminomethyl)benzene, N-(2-ethylhexyl)-1,3-bis(aminomethyl)benzene, 2,2-dimethyl-1,3-propanediamine, 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2 (4),4-trimethyl-1,6-hexanediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- or 1,4-diaminocyclohexane, 1,3-bis(aminomethyl)cyclohexane, 1,4-bis(aminomethyl)cyclohexane, bis(4-aminocyclohexyl) methane, bis(4-amino-3-methylcyclohexyl) methane, bis(4-amino-3-ethylcyclohexyl) methane, bis(4-amino-3,5-dimethylcyclohexyl) methane, bis(4-amino-3-ethyl-5-methylcyclohexyl) methane, 1-amino-3-aminomethyl-3,5,5-trimethylcyclohexane (IPDA), 2 (4)-methyl-1,3-diaminocyclohexane, 2,5 (2,6)-bis(aminomethyl) bicyclo[2.2.1]heptane (NBDA), 3 (4),8 (9)-bis (aminomethyl)tricyclo[5.2.1.0^{2,6}]decane, 1,4-diamino-2,2,6-trimethylcyclohexane (TMCDA), 1,8-menthanediamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl) polytetrahydrofurans or other polytetrahydrofurandiamines, polyoxyalkylenedi- or -triamines, in particular polyoxypropylenediamines or polyoxypropylenetriamines such as Jeffamine® D-230, Jeffamine® D-400 or Jeffamine® T-403 (all from Huntsman), furan-based amines such as N-furfurfuryl-1.2-ethanediamine, 2,5-bis(aminomethyl) furan, 2,5-bis(aminomethyl)tetrahydrofuran, bis(5-aminomethylfuran-2-yl) methane, bis(5-aminomethyltetrahydrofuran-2-yl) methane, 2,2-bis(5-aminomethylfuran-2-yl) propane or 2,2-bis(5-aminomethyltetrahydrofuran-2-yl) propane, or diethylentriamine (DETA), triethylenetetramine (TETA), tetraethylenepentamine (TEPA), pentaethylenehexamine (PEHA), dipropylenetriamine (DPTA), N-(2-aminoethyl)-1,3-propanediamine (N3-amine), N,N′-bis(3-aminopropyl)ethylenediamine (N4-amine), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine, N,N′-bis(3-amino-1-ethylpropyl)-2-methyl-1,5-pentanediamine, 3-(2-aminoethyl)aminopropylamine, bis(hexamethylene)triamine (BHMT), N-aminoethylpiperazine, 3-dimethylaminopropylamine (DMAPA), 3-(3-(dimethylamino) propylamino) propylamine (DMAPAPA), amine-functional adducts of the recited amines with epoxides, phenalkamines, which are reaction products of cardanol with aldehydes, in particular formaldehyde, and polyamines, or a mixture of two or more of these amines.

The hardener preferably contains at least one amine selected from the group consisting of N-benzyl-1,2-ethanediamine, N, N′-dibenzyl-1,2-ethanediamine, MPMD, TMD, 1,2-diaminocyclohexane, 1,3-bis(aminomethyl)cyclohexane, 1,4-bis(aminomethyl)cyclohexane, bis(4-aminocyclohexyl) methane, IPDA, 2 (4)-methyl-1,3-diaminocyclohexane, MXDA, DETA, TETA, TEPA, N3-amine, N4-amine, DPTA, BHMT, polyoxypropylenediamines having an average molecular weight Mn in the range from 200 to 500 g/mol, polyoxypropylenetriamines having an average molecular weight Mn in the range from 300 to 500 g/mol, N-furfuryl-1,2-ethanediamine, 2,5-bis(aminomethyl) furan, 2,5-bis(aminomethyl)tetrahydrofuran, bis(5-aminomethylfuran-2-yl) methane, bis(5-aminomethyltetrahydrofuran-2-yl) methane, 2,2-bis(5-aminomethylfuran-2-yl) propane, 2,2-bis(5-aminomethyltetrahydrofuran-2-yl) propane and phenalkamines.

Preferred among these is IPDA. This achieves particularly high glass transition temperatures which allows particularly good robustness towards high usage temperatures. It is particularly preferable to employ IPDA having a high RCI from biobased acetone which makes it possible to achieve particularly sustainable hardeners.

Further preferred among these is N-benzyl-1,2-ethanediamine. Such a hardener allows particularly low-viscosity epoxy resin products with particularly attractive surfaces.

Also preferred among these is N-furfuryl-1,2-ethanediamine. Such a hardener is particularly sustainable and provides for particularly low-viscosity epoxy resin products with particularly attractive surfaces.

Further preferred among these are 2,5-bis(aminomethyl) furan, 2,5-bis(aminomethyl)tetrahydrofuran, bis(5-aminomethylfuran-2-yl) methane, bis(5-aminomethyltetrahydrofuran-2-yl) methane, 2,2-bis(5-aminomethylfuran-2-yl) propane or 2,2-bis(5-aminomethyltetrahydrofuran-2-yl) propane, in particular 2,5-bis(aminomethyl) furan. Such hardeners are particularly sustainable.

The hardener may in particular contain more than one further amine not conforming to formula (I).

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the abovementioned acids and acid esters; nitrates such as calcium nitrate in particular; tertiary amines such as, in particular, 1,4-diazabicyclo[2.2.2]octane, benzyldimethylamine, α-methylbenzyldimethylamine, triethanolamine, dimethylaminopropylamine, imidazoles such as, in particular, N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, phenols, especially bisphenols, phenolic resins or Mannich bases such as, in particular, 2-(dimethylaminomethyl) phenol, 2,4,6-tris(dimethylaminomethyl) phenol or polymers produced from phenol, formaldehyde and N, N-dimethylpropane-1,3-diamine, phosphites such as, in particular, di- or triphenyl phosphites, or compounds having mercapto groups.

Preference is given to acids, nitrates, tertiary amines or Mannich bases, especially salicylic acid, calcium nitrate or 2,4,6-tris(dimethylaminomethyl) phenol, or a combination of these accelerators.

A hardener containing an amine of formula (If) is preferably free from 2,4,6-tris(dimethylaminomethyl) phenol.

Suitable diluents are especially n-propanol, isopropanol, n-butanol, isobutanol, tert-butanol, 1-pentanol, 2-pentanol, 3-pentanol, 2-methyl-1-butanol, 3-methyl-1-butanol, 3-methyl-2-butanol, n-hexanol, 2-ethylhexanol, xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, mineral oil fractions, for example Solvesso® grades (Exxon), alkylphenols such as tert-butylphenol, nonylphenol, dodecylphenol, cardanol, styrenated phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preference among these is given to diluents having a boiling point of more than 200° C., especially benzyl alcohol, styrenated phenol, ethoxylated phenol, aromatic hydrocarbon resins containing phenol groups, such as in particular the Novares® grades LS 500, LX 200, LA 300 or LA 700 (from Rütgers), diisopropylnaphthalene or cardanol, especially benzyl alcohol.

Phenol-containing diluents are also effective as accelerators.

Preference among these is given also to aromatic diluents having a particularly high diluting effect, especially xylene.

Particular preference among these is given to diluents having an RCI von 1, in particular cardanol. These make it possible to achieve a particularly sustainable hardener.

The hardener preferably contains only a small content of diluents, in particular 0% to 50% by weight, preferably 0% to 30% by weight, of diluents based on the overall hardener.

The hardener preferably contains 1% to 99% by weight, more preferably 2% to 90% by weight, more preferably preferably 2% to 80% by weight, particularly preferably 2% to 70% by weight, of amines of formula (I) based on the overall hardener.

A hardener comprising amine of formula (If) preferably contains 1% to 80% by weight, particularly preferably 2% to 50% by weight, especially 2% to 20% by weight, of amine of formula (If) based on the overall hardener.

A hardener comprising amines of formula (I) where R¹ is methyl and R³ is H preferably contains 5% to 90% by weight, in particular 10% to 70% by weight, of amines of formula (I) based on the overall hardener.

The hardener may be water-based and contain water in the range from 15% to 90% by weight, preferably 20% to 80% by weight.

The hardener is preferably not water-based. It preferably contains less than 15% by weight, especially less than 10% by weight, of water, based on the overall hardener. Such a hardener is particularly suitable for nonaqueous epoxy resin products.

The hardener may contain further constituents, especially:
further adducts, especially adducts of MPMD or 1,2-ethanediamine or 1,2-propanediamine with cresyl glycidyl ether or aromatic epoxy resins, in which unreacted MPMD, 1,2-ethanediamine or 1,2-propanediamine has been removed by distillation after the reaction,
monoamines such as, in particular, benzylamine or furfurylamine,
polyamidoamines, especially reaction products of a mono- or polybasic carboxylic acid, or the ester or anhydride thereof, especially a dimer fatty acid, with a polyamine used in stoichiometric excess, especially DETA or TETA,
Mannich bases,
aromatic polyamines such as in particular 4,4′-, 2,4′ and/or 2,2′-diaminodiphenylmethane, 2,4 (6)-toluenediamine, 3,5-dimethylthio-2,4 (6)-toluenediamine or 3,5-diethyl-2,4 (6)-tolylenediamine,
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol,
surface-active additives, especially defoamers, deaerating agents, wetting agents, dispersants or levelling agents, or
stabilizers, especially stabilizers against oxidation, heat, light or UV radiation.

The invention further provides an epoxy resin composition comprising
a resin component comprising at least one epoxy resin and
a hardener component comprising the hardener containing at least one amine of formula (I) as described hereinabove.

Suitable epoxy resins especially include the aforementioned, in particular bisphenol A diglycidyl ether and/or bisphenol F diglycidyl ether, phenol-formaldehyde novolac glycidyl ether or in particular epoxy resins having a high RCI such as bisphenol A diglycidyl ether from the reaction of bisphenol A with biobased epichlorohydrin or in particular vanillin alcohol diglycidyl ether or the glycidyl ethers of glycerol or polyglycerol.

The resin component may comprise a reactive diluent.

Preferred reactive diluents are reactive diluents containing epoxy groups, especially butanediol diglycidyl ether, hexanediol diglycidyl ether, trimethylolpropane di-r triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as, in particular, C₈ to C₁₀ or C₁₂ to C₁₄ or C₁₃ to C₁₅ alkyl glycidyl ethers.

It is preferable when the epoxy resin composition contains at least one further constituent selected from the group consisting of diluents, accelerators, fillers, pigments, and surface-active additives.

Suitable diluents or accelerators especially include those mentioned hereinabove.

Suitable fillers especially include ground or precipitated calcium carbonate, optionally coated with fatty acid, especially stearates, baryte (heavy spar), talc, quartz flour, quartz sand, silicon carbide, iron mica, dolomite, wollastonite, kaolin, mica (potassium aluminum silicate), molecular sieves, aluminum oxide, zinc oxide, aluminum-doped zinc oxide, aluminum hydroxide, magnesium hydroxide, silica, cement, gypsum, fly ash, carbon black, graphite, metal powders such as aluminum, copper, iron, zinc, silver or steel, PVC powder or hollow beads, and also biobased fillers, such as lignin powder or pulverized nutshells or fruit stones. Preference among these is given to calcium carbonate, baryte, quartz powder, talc, aluminum powder, biobased fillers or a combination thereof.

Suitable pigments especially include titanium dioxides, iron oxides, chromium (III) oxides, organic pigments, carbon black or anticorrosion pigments, especially phosphates, orthophosphates or polyphosphates containing especially chromium, zinc, aluminum, calcium, strontium or a combination of these metals as counterions. Titanium dioxides are particularly suitable.

Suitable surface-active additives are especially defoamers, deaerating agents, wetting agents, dispersants, levelling agents and/or dispersed paraffin waxes.

The epoxy resin composition may optionally comprise further auxiliaries and additives, especially the following:
reactive diluents, especially those already mentioned, or epoxidized soybean oil or linseed oil, compounds containing acetoacetate groups, especially acetoacetylated polyols, butyrolactone, carbonates, aldehydes, isocyanates or silicones having reactive groups;
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl(meth)acrylates, especially chlorosulfonated polyethylenes or fluorine-containing polymers or sulfonamide-modified melamines;
fibers, in particular glass fibers, carbon fibers, metal fibers, ceramic fibers, hemp fibers, cellulose fibers or plastics fibers such as polyamide fibers or polyethylene fibers;
nanofillers, especially carbon nanotubes;
rheology modifiers, especially thickeners or antisettling agents;
adhesion improvers, especially organoalkoxysilanes;
flame-retardant substances, especially the aluminum hydroxide or magnesium hydroxide fillers already mentioned, antimony trioxide, antimony pentoxide, boric acid (B(OH) 3), zinc borate, zinc phosphate, melamine borate, melamine cyanurate, ammonium polyphosphate, melamine phosphate, melamine pyrophosphate, polybrominated diphenyl oxides or diphenyl ethers, phosphates such as, in particular, diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl)phosphate, tris(chloropropyl)phosphate, tris(dichloroisopropyl)phosphate, tris[3-bromo-2,2-bis(bromomethyl) propyl]phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy) ethane, tris(2,3-dibromopropyl) isocyanurate, tribromophenol, hexabromocyclododecane, bis(hexachlorocyclopentadieno)cyclooctane or chloroparaffins; or
stabilizers against oxidation, heat, light or UV radiation or biocides;
   The epoxy resin composition preferably has only a low content of diluents. It preferably contains less than 20% by weight, particularly preferably less than 10% by weight, in particular less than 5% by weight, most preferably less than 1% by weight, of diluent.

The epoxy resin composition may contain water.

In one embodiment the epoxy resin composition is water-based. The epoxy resin is preferably emulsified in an amount of 50% to 85% by weight in water and the hardener component preferably contains 20% to 80% by weight of water. The epoxy resin composition preferably contains only a low content of water, preferably less than 5% by weight, especially less than 1% by weight, of water. Such a non-water-based epoxy resin composition is particularly versatile and particularly water-resistant.

Preference is given to an epoxy resin composition comprising
a resin component containing at least one epoxy resin and optionally further constituents such as in particular epoxy-containing reactive diluents, diluents, fillers, pigments and/or surface-active additives, and
a hardener component containing at least one amine of formula (I) and optionally further constituents such as in particular further amines, accelerators and/or diluents.

The resin component and the hardener component of the epoxy resin composition are stored in separate receptacles.

A suitable container for storage of the resin component or the hardener component is especially a vat, a hobbock, a bag, a bucket, a can, a cartridge or a tube. The components are storable, meaning that they can be stored prior to use for several months up to one year or longer without any change in their respective properties to a degree relevant to their use.

The resin component and hardener component are mixed shortly before or during application. The mixing ratio is preferably chosen such that the molar ratio of epoxy-reactive groups to epoxy groups is in the range from 0.5 to 1.5, especially 0.7 to 1.2. In parts by weight, the mixing ratio between the resin component and the hardener component is typically within a range from 1:2 to 20:1.

The components are mixed continuously or in batches by means of a suitable method, taking care to ensure that not too much time elapses between the mixing of the components and the application, and that application takes place within the pot life. Mixing and application can be effected at ambient temperature, which is typically in the range from about 5° C. to 40° C., preferably about 10° C. to 35° C., or at elevated temperature, especially in the range from 40° C. to 150° C., preferably 50° C. to 120° C.

Upon mixing the components, the curing of the epoxy resin composition by chemical reaction commences. Primary and secondary amino groups, and any further groups present that are reactive toward epoxy groups, react with the epoxy groups, resulting in ring opening thereof. In addition, a phenol-containing amine of formula (I) catalyzes the homopolymerization of the epoxy groups. As a result primarily of these reactions, the composition polymerizes and thereby cures. Curing typically extends over a few hours to days. The duration depends on factors including the temperature, the reactivity of the constituents, the stoichiometry thereof, and the presence/amount of accelerators.

In the freshly mixed state the epoxy resin composition preferably has a low viscosity. The viscosity 5 minutes after mixing of the resin component and the hardener component at 20° C. is preferably in the range from 0.1 to 50 Pa's, preferably 0.2 to 20 Pas, particularly preferably 0.3 to 10 Pas, measured using a cone-plate viscometer at a shear rate of 10 s-1.

The epoxy resin composition is applied to at least one substrate and/or to at least one casting mold.

Suitable substrates are especially:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), natural fiber-reinforced plastics (NFRP) and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

The substrates can if required be pretreated prior to application, especially by physical and/or chemical cleaning methods or the application of an activator or a primer.

The substrates are especially coated and/or adhesively bonded.

A suitable casting mold is an apparatus into which the mixed, liquid epoxy resin composition is poured and in which it is cured, and from which it is or can be demolded after curing, where the cured composition forms a shaped body.

The casting mold preferably consists at least of a material on the surface, from which the cured epoxy resin composition can be parted again without damage, especially made of metal, ceramic, plastic or silicone, optionally provided with a nonstick coating, especially of Teflon, silicone or a wax.

The invention further provides a cured composition obtained from the epoxy resin composition described after mixing of the resin component and the hardener component.

The epoxy resin composition is preferably used as a coating, primer, adhesive, sealant, potting compound, casting resin, impregnating resin, or as a shaped body or matrix for composite materials such as, in particular, CFRP (containing carbon fibers), GFRP (containing glass fibers), NFRP (containing natural fibers) or wood composites, wherein the obtained products are particularly sustainable.

The use forms said article containing the cured composition composed of the described epoxy resin composition.

The article is in particular a floor coating, wall coating, component coating, pipe coating, roof coating or an anticorrosion coating or an adhesive-bonded article or a shaped body, in particular a composite material.

### EXAMPLES

The following are exemplary embodiments which are intended to more particularly elucidate the described invention. It goes without saying that the invention is not limited to these described exemplary embodiments.

“AHEW” stands for amine hydrogen equivalent weight.

“EEW” stands for epoxy equivalent weight.

“Standard climatic conditions” (“SCC”) refer to a temperature of 23±1° C. and a relative atmospheric humidity of 50±5%.

The chemicals used were from Sigma-Aldrich Chemie GmbH, unless otherwise stated.

Description of the measurement methods: Gas chromatograms (GC) were measured in the temperature range from 60° C. to 320° C. with a heating rate of 15° C./min and a 10 min hold time at 320° C. The injector temperature was 250° C. A Zebron ZB-5 column was used (L=30 m, ID=0.25 mm, dj=0.5 μm) at a gas flow of 1.5 ml/min. Detection was by flame ionization (FID).

Infrared spectra (FT-IR) were measured as undiluted films on a Nicolet iS5 FT-IR instrument from Thermo Scientific equipped with a horizontal ATR measurement unit with a diamond crystal. Absorption bands are reported in wavenumbers (cm-1).

¹H and ¹³C NMR spectra were measured at room temperature on a spectrometer of the Bruker Ascend type at 400.14 MHz (1H) or 100.63 MHZ (13C); the chemical shifts δ are reported in ppm relative to tetramethylsilane (TMS). Coupling constants J are reported in Hz. No distinction was made between true coupling and pseudo-coupling patterns.

Viscosity was measured on a thermostated Rheotec RC30 cone-plate viscometer (cone diameter 50 mm, cone angle 1°, cone tip-plate distance 0.05 mm, shear rate 10 s-1).

Amine value was determined by titration (with 0.1 N HCIO4 in acetic acid against crystal violet).

### Substances and Abbreviations Used:

| | |
|---|---|
| Vanillin | EuroVanillin Supreme, RCI = 1 (Borregaard) |
| Araldite ® | Bisphenol A diglycidyl ether, EEW approx. 187 g/eq |
| GY 250 | (Huntsman) |
| Araldite ® | Monoglycidyl ethers of C₁₂ to C₁₄ alcohols, EEW |
| DY-E | about 290 g/eq (Huntsman) |
| MXDA | 1,3-bis(aminomethyl)benzene, AHEW 34 g/eq |
| | (Mitsubishi Gas Chemical) |
| Dibenzyl | N, N′-dibenzyl-1,3-bis(aminomethyl)benzene, AHEW |
| MXDA | about 158.2 g/eq, produced by reductive alkylation of |
| | MXDA and benzaldehyde in a molar ratio of 1:2 |
| Diethylhexyl | N, N′-bis(2-ethylhexyl)-1,3-bis(aminomethyl)benzene, |
| MXDA | AHEW about 180.3 g/eq, produced by reductive |
| | alkylation of MXDA and 2-ethylhexanal in a molar |
| | ratio of 1:2 |
| B-EDA | N-benzyl-1,2-ethanediamine, AHEW 50.1, produced |
| | by reductive alkylation of 1,2-ethanediamine and |
| | benzaldehyde in a molar ratio of 3:1 and subsequent |
| | purification by distillation |
| Ancamine ® | 2,4,6-tris(dimethylaminomethyl)phenol (Evonik) |
| K54 | |

### Production of Dialdehydes:

4-hydroxy-5-methoxyisophthalaldehyde (=5-formylvanillin) In a round-bottom flask 100.61 g (0.661 mol) of vanillin (4-hydroxy-3-methoxybenzaldehyde) and 110.96 g (0.791 mol) of hexamethylenetetramine (1,3,5,7-tetraazaadamantane) were initially charged under a nitrogen atmosphere and admixed with 500 ml of trifluoroacetic acid. The reaction mixture was boiled under reflux at about 125° C. for 5 h with stirring. 800 ml of aqueous HCl (4 M) were then added and the mixture was boiled under reflux at about 125° C. for a further hour and the reaction mixture was then cooled to room temperature and extracted with altogether 600 ml of dichloromethane. The combined organic phase was dried over magnesium sulfate and concentrated by rotary evaporator and the obtained solid residue was recrystallized from toluene and dried under vacuum. 98.15 g (0.54 mol) of a yellowish powder having a purity of >99% determined by GC (in ethyl acetate) (retention time 11.12 min) were obtained. ¹H-NMR (DMSO-d6): 11.30 (br s, 1H, Ar—OH), 10.36 (s, 1H, O═CH 3-position), 9.89 (s, 1H, O═CH 1-position), 7.88 (d, 1H, Ar—H, J=1.8), 7.61 (d, 1H, Ar—H, J=1.8), 3.96 (s, 3H, OCH₃).

¹³C NMR (CDCl₃): 55.46 (OCH₃), 113.26 (Ar—CH), 119.00 (Ar—CH), 128.08 (Ar—C—CHO 3-position), 128.46 Ar—C—CHO 1-position), 148.42 (Ar—C—OCH₃), 156.09 (Ar—C—OH), 188.56 (CHO 3-position), 194.83 (CHO 1-position)

FT-IR: 3073, 3032, 2991, 2939, 2873, 2733, 2508, 2559, 1683, 1640, 1615, 1588, 1557, 1538, 1502, 1467, 1453, 1435, 1407, 1385, 1323, 1293, 1276, 1200, 1183, 1145, 1090, 1029, 1015, 982, 956, 908, 883, 830, 809, 797, 763, 732, 666.

### 4,5-Dimethoxyisophthalaldehyde

In a round-bottom flask 5.01 g (27.8 mmol) of 4-hydroxy-5-methoxyisophthalaldehyde (produced as described above) were initially charged under a nitrogen atmosphere, dissolved in 130 ml of dimethylformamide, admixed with 11.53 g of potassium carbonate and 0.46 g of tetrabutylammonium iodide and stirred at room temperature for 2 h. Subsequently, 8.09 g (55.6 mmol) of dimethyl sulfate were added slowly and the reaction mixture stirred at room temperature for 24 h. Then, 40 ml of aqueous sodium hydroxide solution (1 M) were added, the reaction mixture was concentrated by rotary evaporator and the obtained solid was dissolved in water and extracted with 300 ml of ethyl acetate. The combined organic phase was dried over magnesium sulfate, concentrated by rotary evaporator and dried under vacuum. 5.61 g (26.7 mmol) of a yellowish powder having a purity of >99% determined by GC in ethyl acetate (retention time 11.49 min) were obtained.

¹H NMR (CDCl₃): 10.38 (s, 1H, O═CH 3-position), 9.87 (s, 1H, O═CH 1-position), 7.86 (d, 1H, Ar—H, J=1.92), 7.59 (d, 1H, Ar—H, J=1.92), 4.05 (s, 3H, OCH₃), 3.91 (s, 3H, OCH₃).

¹³C NMR (CDCl₃): 55.24 (OCH₃), 61.35 (OCH₃), 113.26 (Ar—CH), 123.42 (Ar—CH), 128.42 (Ar—C—CHO 3-position), 131.13 (Ar—C—CHO 1-position), 152.64 (Ar—C—O), 156.49 (Ar—C—O), 188.02 (CHO 3-position), 189.46 (CHO 1-position).

FT-IR: 3020, 2954, 2873, 2849, 1682, 1597, 1581, 1516, 1485, 1463, 1428, 1386, 1335, 1284, 1248, 1227, 1190, 1133, 1071, 1009, 982, 934, 891, 873, 786, 764, 751.

### Preparation of Amines of the Formula (I):

### Amine A1:1,3-Bis(Aminomethyl)-4,5-Dimethoxybenzene

In a round-bottom flask 49.22 g (0.6 mol) of sodium acetate and 29.09 g (0.44 mol) of aqueous hydroxylamine (50% by weight in water) were dissolved in 500 ml of water under a nitrogen atmosphere. Subsequently, 38.38 g (0.2 mol) of 4,5-dimethoxyisophthalaldehyde (produced as described above) were added and the reaction mixture was boiled under reflux at about 110° C. for 1.5 h, cooled in an ice bath and the white precipitate filtered off, washed with 300 ml ice-cold water and dried under vacuum. This afforded 35.54 g (0.16 mol) of 4.5-dimethoxyisophthalaldehyde dioxime as a white crystalline powder. 20 g (0.089 mol) thereof were dissolved in a mixture of 100 ml of ethanol and 1200 ml of 1,4-dioxane in a round-bottom flask and hydrogenated in a continuous hydrogenation apparatus with a Raney nickel fixed bed catalyst at a hydrogen pressure of 80 bar, a temperature of 80° C. and a flow rate of 5 ml/min. The reaction was monitored by using IR spectroscopy to check whether the C═N band at about 1665 cm-1 had disappeared. The hydrogenated solution was then concentrated by rotary evaporator at 65° C. This afforded 16.12 g (0.086 mol) of a yellowish liquid having an amine number of 519 mg KOH/g, a theoretical AHEW of about 49.1 g/eq, an RCI of 0.8, a viscosity at 20° C. of 277 mPa's and a content of 1,3-bis(aminomethyl)-4,5-dimethoxybenzene determined by GC in ethyl acetate of about 92% (retention time 14.59 min).

¹H-NMR (DMSO-d6): 6.92 (s, 1H, Ar—H), 6.90 (s, 1H, Ar—H), 3.79 (s, 3H, OCH₃), 3.70 (s, 3H, OCH₃), 3.67 (s, 2H, CH₂—N), 3.66 (s, 2H, CH₂—N), 1.81 (br s, 4H, 2x NH₂).

¹³C-NMR (DMSO-d6): 41.04 (CH₂—N), 46.22 (CH₂—N), 56.00 (OCH₃), 60.48 (OCH₃), 110.32 (Ar—CH), 119.02 (Ar—CH), 137.31 (Ar—C—CH₂), 140.33 (Ar—C—CH₂), 144.89 (Ar—C—O), 152.30 (Ar—C—O).

FT-IR: 3367, 3284, 3189, 2994, 2932, 2831, 1588, 1488, 1462, 1428, 1383, 1338, 1309, 1225, 1185, 1139, 1080, 1051, 1005, 838, 775, 741, 706.

### Amine A2:1,3-Bis(Furfurylaminomethyl)-4,5-Dimethoxybenzene

In a round-bottom flask 10.0 g (51.5 mmol) of 4,5-dimethoxyisophthalaldehyde (produced as described above) were dissolved in 400 ml of isopropyl alcohol, 10.5 g (10.8 mmol) of furfurylamine were slowly added with stirring and the mixture was stirred at room temperature for a further 30 min. The reaction mixture was was then hydrogenated in a continuous hydrogenation apparatus with a Raney nickel fixed bed catalyst at a hydrogen pressure of 70 bar, a temperature of 70° C. and a flow rate of 5 ml/min. The reaction was monitored by using IR spectroscopy to check whether the C═N band at about 1665 cm-1 had disappeared. The hydrogenated solution was then concentrated by rotary evaporator at 65° C. This afforded 16.4 g of a clear, yellow liquid having an amine number of 297 mg KOH/g, a theoretical AHEW of about 178.2 g/eq, an RCI of 0.9, a viscosity at 20° C. of 910 mPa's and a content of 1,3-bis(furfurylaminomethyl)-4,5-dimethoxybenzene determined by GC of about 88.4% (retention time 18.96 min) and about 11.6% byproduct (retention time 19.26 min).

FT-IR: 3324, 2935, 2867, 2834, 1589, 1488, 1455, 1428, 1359, 1310, 1227, 1180, 1145, 1067, 1008, 919, 847, 776.

### Amine A3:2,4-Bis(Dimethylaminomethyl)-6-Methoxyphenol

In a round-bottom flask 10 g (55 mmol) of 4-hydroxy-5-methoxyisophthalaldehyde (=5-formylvanillin produced as described above), 60 g (120 mmol) of dimethylamine solution (2M in tetrahydrofuran) and 150 ml of tetrahydrofuran were initially charged and cooled with ice water. An orange-red coloring was formed. 35 g of sodium triacetoxyborohydride were then added and the reaction mixture was stirred for 1 h with ice water cooling, then for 1 h at room temperature and then for 1 h at 40° C., whereupon the reaction mixture showed a yellowish coloring. The reaction mixture was then admixed with 75 ml of a potassium carbonate solution (15% by weight in water) and stirred at room temperature for 30 min, whereupon the reaction mixture became almost colorless. Then the reaction mixture was concentrated by rotary evaporator at 80° C., the residue was taken up in tetrahydrofuran, the undissolved potassium carbonate was filtered off and the filtrate was concentrated by rotary evaporator at 65° C. This afforded 12.4 g of an orange oil which was subjected to vacuum distillation at 107° C. to 120° C. and 250 mbar to afford 7.5 g of a yellowish oil having an amine number of 467 mg KOH/g. ¹H NMR (CDCl₃): 6.77 (d, 1H, Ar—H), 6.52 (d, 1H, Ar—H), 3.87 (t, 3H, OCH₃), 3.62 (t, 2H, CH₂N), 3.32 (t, 2H, CH₂N), 2.32 (t, 6H, (CH₃) 2N), 2.23 (t, 6H, (CH₃) 2N).

### Amine A4: Amine Mixture Containing 2,4-Bis(Dimethylaminomethyl)-6-Methoxyphenol

In a round-bottom flask 24.83 g (0.2 mol) of guaiacol, 81.96 g (0.6 mol) of dimethylamine solution (33% by weight in ethanol) were initially charged in 250 ml of ethanol and admixed with 18.20 g (0.6 mol) of paraformaldehyde. The reaction mixture was heated under reflux for 10 h, then freed of volatile constituents at 65° C. under vacuum by rotary evaporator and then subjected to vacuum distillation at 120° C. to collect 25.6 g of distillate at a vapor temperature of about 100° C. and 0.005 bar. This afforded 45.3 g of distillate as a yellowish clear liquid having an amine number of 452 mg KOH/g. According to 1H-NMR the content of 2,4-bis(dimethylaminomethyl)-6-methoxyphenol was about 89% and the main byproduct present was 2 (4)-dimethylaminomethyl-6-methoxyphenol.

¹H NMR (CDCl₃): 6.75 (d, 1H, Ar—H), 6.57 (d, 1H, Ar—H), 3.74 (s, 3H, OCH₃), 3.53 (s, 2H, CH₂N), 3.24 (s, 2H, CH₂N), 2.21 (s, 6H, (CH₃) 2N), 2.11 (2, 6H, (CH₃) 2N).

### Production of Epoxy Resin Adhesives:

### Examples 1 and 2

The resin component employed was Sikadur®-42 HE component A (reactive diluent-diluted bisphenol A diglycidyl ether, EEW 175.5 g/eq, Sika) in the amount specified in table 1 (in parts by weight).

The hardener component employed was the amine specified in table 1 in the specified amount (in parts by weight).

Subsequently the two components for each example were mixed using a centrifugal mixer (SpeedMixer™ DAC 150, FlackTek Inc.) and immediately tested as follows:

Viscosity was measured as described at a temperature of 20° C. 5 min after mixing the resin component and the hardener component.

Gel time was determined by touching the surface of a freshly mixed amount of about 3 g with an LDPE pipette at regular intervals under standard climatic conditions until no residue remained on the pipette.

Mechanical properties were determined by applying and curing the mixed adhesive in a silicone mold under standard climatic conditions to afford dumbbell-shaped bars having a thickness of 2 mm and a length of 75 mm at a gage length of 30 mm and a gage width of 4 mm. The tensile bars were removed from the mold after 1 d under standard climatic conditions and after altogether 7 d of curing time under standard climatic conditions used to measure tensile strength, elongation at break and modulus of elasticity (0.05-0.25% elongation) according to EN ISO 527 at a strain rate of 10 mm/min. These results are marked “SCC”. Further of these tensile bars were removed from the mold after 1 d under standard climatic conditions, and then subjected to further curing at 120° C. in a recirculating oven for 1 d and stored under standard climatic conditions for 1 d before the mechanical properties were determined. These results are marked “120° C.”. Further of these tensile bars were removed from the mold after 1 d under standard climatic conditions, and then subjected to further curing at 120° C. in a recirculating oven for 1 d, then stored in water at room temperature for 5 days and then patted dry with a hygiene towel and stored under standard climatic conditions for 1 d before the mechanical properties were determined. These results are marked “H₂O”. The Tg value (glass transition temperature) was determined by DMTA measurements on cylindrical specimens (height 2 mm, diameter 10 mm) stored as described for tensile strength with a Mettler DMA/SDTA 861e instrument measuring in shear mode with a 10 Hz excitation frequency and a 5 K/min heating rate. The samples were cooled to −70° C. and heated to 200° C. while determining the complex modulus of elasticity M*[MPa], wherein a maximum in the curve for the loss angle “tan 0” was read off as the Tg value.

The results are reported in table 1.

Comparative examples are marked “(Ref.)”.

TABLE 1
Composition and properties
of examples 1 and 2.

| | | | 2 |
|---|---|---|---|
| Example | | 1 | (Ref.) |
| Resin component: | | | |
| Sikadur ®-42 HE component A | | 175.5 | 175.5 |
| Hardener component: | | | |
| Amine A1 ¹ | | 49.1 | — |
| MXDA | | — | 34.0 |
| Viscosity (5′) [Pa · s] | | 1.47 | 0.74 |
| Gel time | | 1.5 h | >4 h |
| Tensile | SCC | 46.7 | 58.1 |
| strength [MPa] | 120° C. | 72.9 | 68.0 |
| | H₂O | 66.0 | 66.3 |
| Elongation | SCC | 1.6 | 2.3 |
| at break | 120° C. | 7.7 | 6.8 |
| | H₂O | 6.2 | 6.1 |
| Modulus of | SCC | 3320 | 3160 |
| elasticity [MPa] | 120° C. | 3120 | 2995 |
| | H₂O | 2980 | 3070 |
| Tg [°C] | SCC | 62 | 58 |
| | 120° C. | 88 | 84 |
| | H₂O | 82 | 82 |

¹ produced as described above

### Production of Epoxy Resin Coatings:

### Examples 3 to 10

For each example, the ingredients of the resin component specified in tables 2 and 3 were mixed in the specified amounts (in parts by weight) using the centrifugal mixer and stored with exclusion of moisture.

The ingredients of the hardener component specified in tables 2 and 3 were likewise processed and stored.

Subsequently the two components for each example were mixed using the centrifugal mixer and immediately tested as follows: Viscosity and gel time were determined as described for example 1.

Shore D hardness was determined according to DIN 53505 on two cylindrical test specimens (diameter 20 mm, thickness 5 mm), wherein one was stored under standard climatic conditions and the other at 8° C. and 80% relative humidity and hardness was in each case measured after 1 d and after 2 d.

In addition, a film was applied to a glass plate in a layer thickness of 500 μm, and this was stored/cured under standard climatic conditions. König hardness (König pendulum hardness according to DIN EN ISO 1522) was determined on this film after 1 d, 2 d, 7 d and after 14 d (1 d SCC), (2 d SCC), (7 d SCC), (14 d SCC). After 14 d the appearance (SCC) of the film was assessed. A clear film was described as “attractive” if it had a glossy and nontacky surface with no structure.

“Structure” refers to any kind of marking or pattern on the surface. A further film was applied to a glass plate in a layer thickness of 500 μm and, immediately after application, stored/cured at 8° C. and 80% relative humidity for 7 d and then under standard climatic conditions for 2 weeks. 24 hours after application, a polypropylene bottle top beneath which a moist sponge had been positioned was placed on the film. After a further 24 hours, the sponge and the bottle top were removed and positioned at a new point on the film, from which they were in turn removed and repositioned after 24 hours, which was done 4 times in total. The appearance of this film was then assessed (referred to as “appearance (8°/80%)” in the tables) in the same way as described for appearance (SCC). The number and nature of visible marks that had formed in the film as a result of the moist sponge were also reported in each case. The number of white discolored spots was reported as “marks”. A faint white discolored spot was designated as “(1)”. A clear white discolored spot was designated as “1”. The films cured in this way in turn had their Konig hardness determined, in each case after 7 days at 8° C. and 80% relative humidity (König (7d 8°/80%)), then after a further 2 days under SCC(König (+2d SCC)) or 7 days under SCC(König (+7d SCC)) or 14 days under SCC(König (+14d SCC)).

The results are reported in Tables 2 and 3.

Comparative examples are labelled “(Ref.)”.

TABLE 2
Composition and properties of examples 3 to 7.

| | | 3 | | | | 6 | 7 |
|---|---|---|---|---|---|---|---|
| | Example | (Ref.) | 4 | 5 | 5a | (Ref.) | (Ref.) |
| Resin component: | Araldite ® GY-250 | 167.2 | 167.2 | 167.2 | 167.2 | 167.2 | 167.2 |
| | Araldite ® DY-E | 31.8 | 31.8 | 31.8 | 31.8 | 31.8 | 31.8 |
| Hardener | MXDA | 34.0 | — | — | — | | — |
| component: | Amine A1 1 | — | 49.1 | — | — | | — |
| | Amine A3 1 | — | — | 2.0 | — | | — |
| | Amine A4 1 | — | — | — | 2.0 | | — |
| | B-EDA | — | — | 50.1 | 50.1 | 50.1 | 50.1 |
| | Ancamine ® K54 | — | — | — | — | 2.0 | — |
| Viscosity (5′) | [Pa · s] | n.d. | n.d. | 0.24 | 0.22 | 0.22 | 0.23 |
| Gel time | | n.d. | n.d. | 5 h | 5 h | 5 h | 5 h |
| Shore D | (1 d SCC) | n.d. | n.d. | 72 | 78 | 68 | 60 |
| | (2 d SCC) | | | 77 | 79 | 71 | 62 |
| Shore D | (1 d 8°/80%) | n.d. | n.d. | n.m.² | n.m.² | n.m.² | n.m.² |
| | (2 d 8°/80%) | | | 55 | 58 | 76 | 79 |
| König | (1 d SCC) | 11 | 74 | 164 | 91 | 116 | 52 |
| [s] | (2 d SCC) | 13 | 148 | 183 | 141 | 157 | 131 |
| | (7 d SCC) | 16 | 167 | 190 | 188 | 206 | 142 |
| | (14 d SCC) | 22 | 167 | 205 | 190 | 208 | 145 |
| Appearance | (SCC) | cloudy, | slight | attracttive | attractive | attractive | attractive |
| | | slightly | structure | | | | |
| | | tacky | | | | | |
| König | (7 d 8°/80%) | n.m.³ | 39 | 45 | 36 | 55 | 31 |
| [s] | (+2 d SCC) | n.d. | n.d. | 134 | 99 | 101 | 63 |
| | (+7 d SCC) | n.d. | n.d. | 188 | 145 | 143 | 123 |
| | (+14 d SCC) | n.m.³ | 76 | 188 | 147 | 174 | 169 |
| Appearance | (8°/80%) | cloudy, | slightly | attractive | attractive | attractive | attractive |
| | | tacky | cloudy | | | | |
| Marks | | 4 | 4 | (1) | (1) | (1) | (1) |

¹ produced as described above
²not measurable (too soft)
³not measurable (tacky)
“n.d.” stands for “not determined”

TABLE 3
Composition and properties of examples 8 to 10.

| | | | 9 | 10 |
|---|---|---|---|---|
| Example | | 8 | (Ref.) | (Ref.) |
| Resin component: | | | | |
| Araldite ® GY-250 | | 187.0 | 187.0 | 187.0 |
| Hardener component: | | | | |
| Amine A2 ¹ | | 178.2 | — | — |
| Dibenzyl MXDA | | — | 158.2 | — |
| Diethylhexyl MXDA | | — | — | 180.3 |
| Viscosity (5′) [Pa · s] | | 4.3 | 1.2 | 0.2 |
| Shore D | (1 d SCC) | n.m.² | n.m.² | n.m.² |
| | (2 d SCC) | 50 | n.m.³ | n.m.² |

¹ produced as described above
²too soft
³too brittle/fragile

Production of Polyurethane Adhesives with High Sag Resistance During Application:

### Examples 11 to 13

For each example the ingredients of the polyol component specified in table 4 were mixed in the specified amounts (in parts by weight) using the centrifugal mixer and stored with exclusion of moisture.

The ingredients of the isocyanate component specified in table 4 were also processed and stored.

Subsequently the two components for each example were mixed using the centrifugal mixer and the sag resistance of each composition was immediately determined. To this end, 8 ml of the freshly mixed composition were applied from a commercial 10 ml plastic syringe that had been cut open at the front onto a piece of horizontal cardboard from above, and the cardboard with the applied composition was immediately tipped into the vertical position so that the applied composition projected horizontally. The extent of sagging from the horizontal position downwards during curing under standard climatic conditions was then assessed. A very small amount of sagging was described as “very good” and severe sagging was described as “poor”.

The results are reported in table 4.

Comparative examples are marked “(Ref.)”.

TABLE 4
Composition and properties of examples 11 to 13.

| | | 12 | 13 |
|---|---|---|---|
| Example | 11 | (Ref.) | (Ref.) |
| Polyol component: | | | |
| Voranol ® CP 4755 ¹ | 52.2 | 52.2 | 52.2 |
| 1,4-butanediol | 7.4 | 7.4 | 8.4 |
| Amine A1 | 2.0 | — | — |
| MXDA | — | 2.0 | — |
| Calcined kaolin ² | 33.3 | 33.3 | 33.3 |
| Molecular sieve 3Å | 4.9 | 4.9 | 4.9 |
| DABCO ® 33 LV ³ | 0.2 | 0.2 | 0.2 |
| Isocyanate component: | | | |
| Desmodur ® CD-L ⁴ | 32.3 | 32.3 | 32.3 |
| Polymer-1 ⁵ | 46.2 | 46.2 | 46.2 |
| Pyrogenic silica ⁶ | 3.3 | 3.3 | 3.3 |
| Sag resistance | very good | very good | poor |

¹ EO-capped polyoxypropylenetriol, OH number 34.7 mg KOH/g (Dow)
² Satintone ® W (BASF)
³ 33% by weight 1,4-diazabicyclo[2.2.2]octane in dipropylene glycol (Evonik)
⁴ Carbodiimide-modified diphenylmethane diisocyanate, NCO content 29.5% by weight (Covestro)
⁵ NCO content 2.07% by weight produced as described below
⁶ Aerosil ® 200 (Evonik)

Polymer-1 was produced by reacting 1300 g of polyoxypropylenediol (Acclaim 4200 N, OH number 28.5 mg KOH/g, Covestro), 2600 g of EO-capped polyoxypropylenetriol (Voranol® CP 4755, OH number 34.7 mg KOH/g, Dow), 600 g of 4,4′-diphenylmethane diisocyanate (Desmodur® 44 MC L, Covestro) and 500 g of diisodecyl phthalate by known methods at 80° C. to afford an isocyanate-containing polymer having an NCO content of 2.07% by weight.

1. A method comprising:
forming a hardener composition by adding to a hardener at least one amine of formula (I) 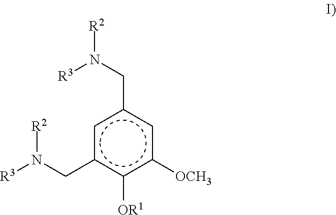
where 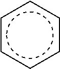
is a benzene ring or cyclohexane ring,
R¹ is H or an alkyl radical having 1 to 6 carbon atoms,
R² is H or a monovalent organic radical having 1 to 6 carbon atoms or an aminoalkyl radical having 2 to 10 carbon atoms or an N-substituted aminoalkyl radical having 2 to 10 carbon atoms and
R³ is H or methyl; and
mixing the hardener composition with an amine-reactive compound such that a crosslinking reaction occurs.

2. The method as claimed in claim 1, wherein the amine-reactive compound is an epoxy resin, polyisocyanate, poly(meth)acrylate, a polycarboxylic acid or a carboxylic anhydride.

3. The method as claimed in claim 1, wherein the amine-reactive compound is an epoxy resin.

4. The method as claimed in claim 1, wherein R¹ is methyl.

5. The method as claimed in claim 4, wherein R² and R³ are both H.

6. The method as claimed in claim 4, wherein R³ is H and R² is a monovalent organic radical having 1 to 6 carbon atoms.

7. The method as claimed in claim 6, wherein R² is furfuryl or tetrahydrofuryl.

8. The method as claimed in claim 1, wherein R¹ is H and 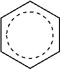
is a benzene ring.

9. The method as claimed in claim 8, wherein R² and R³ are both methyl.

10. The method as claimed in claim 8, wherein R² is furfuryl and R³ is H.

11. The method as claimed in claim 1, wherein R³ is H and R² is a linear aminoalkyl radical having 2 to 6 carbon atoms.

12. The method as claimed in claim 1, wherein R³ is H and R² is an N-substituted aminoalkyl radical having 2 to 10 carbon atoms.

13. The method as claimed in claim 1, wherein in the amine of formula (I) the radicals R² on the two nitrogen atoms are in each case different radicals.

14. The method as claimed in claim 3, wherein the hardener contains at least one further constituent selected from further amines not conforming to formula (I), accelerators and diluents.

15. An epoxy resin composition comprising
a resin component comprising at least one epoxy resin and
a hardener component comprising the hardener as described in claim 4.

16. A cured epoxy resin composition obtained from the epoxy resin composition as claimed in claim 15 after the mixing of the resin component and the hardener component.

17. A hardener for crosslinking amine-reactive compounds, the hardener containing at least one amine of formula (I) 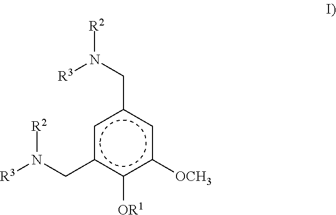
where 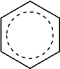
is a benzene ring or cyclohexane ring,
R¹ is H or an alkyl radical having 1 to 6 carbon atoms,
R² is H or a monovalent organic radical having 1 to 6 carbon atoms or an aminoalkyl radical having 2 to 10 carbon atoms or an N-substituted aminoalkyl radical having 2 to 10 carbon atoms and
R³ is H or methyl.

18. The hardener as claimed in claim 17, wherein the amine-reactive compound is an epoxy resin, polyisocyanate, poly(meth)acrylate, a polycarboxylic acid or a carboxylic anhydride.

19. The hardener as claimed in claim 17, wherein the amine-reactive compound is an epoxy resin

20. The hardener as claimed in claim 17, wherein R¹ is methyl.
